(19) United States
(12) Patent Application Publication
(10) Pub. No.: US 2026/0126074 A1
(43) Pub. Date: May 7, 2026

(54) MULTI-PIECE FASTENERS AND METHODS FOR FASTENING

(71) Applicant: HOWMET AEROSPACE INC., Pittsburgh, PA (US)

(72) Inventors: Dieter JÜLING, Kelkheim (DE); Christian SCHNEPPE, Oberursel (DE)

(21) Appl. No.: 19/119,952

(22) PCT Filed: Nov. 18, 2022
(86) PCT No.: PCT/US2022/080125

§ 371 Date: Apr. 10, 2025

(51) Int. Cl. F16B 21/16; F16B 35/04; F16B 39/24

(52) U.S. Cl. CPC F16B 21/16; F16B 35/041; F16B 39/24

(57) ABSTRACT

The present disclosure relates to multi-piece fasteners and methods for fastening. The multi-piece fastener comprises a pin, a sleeve, a first ratchet ring, and a second ratchet ring. The sleeve comprises a first sleeve end, a second sleeve end, an elongate portion extending from the first sleeve end to the second sleeve end, and an inner surface extending into the elongate portion from the first sleeve end. The inner surface defines a sleeve cavity. The first ratchet ring is disposed within the sleeve cavity and configured to engage the pin. The first ratchet ring comprises a first bore configured to receive the pin. The second ratchet ring is disposed within the sleeve cavity and configured to engage the sleeve. The second ratchet ring comprises a second bore configured to receive the pin. The first ratchet ring is configured to engage the second ratchet ring.

### FIELD OF USE

The present disclosure relates to multi-piece fasteners and methods for fastening.

### BACKGROUND

Vehicle frames, storage racks, solar panel sub-structures, aircraft parts, electrical panels, and other structures can include numerous mechanical fasteners. For example, a mechanical fastener can be installed in a bore of a structural component to secure parts together. Properly installing a mechanical fastener into a bore with a desired torque presents challenges.

### SUMMARY

According to one non-limiting aspect of the present disclosure, a multi-piece fastener is provided. The multi-piece fastener comprises a pin, a sleeve, a first ratchet ring, and a second ratchet ring. The sleeve comprises a first sleeve end, a second sleeve end, an elongate portion extending from the first sleeve end to the second sleeve end, and an inner surface extending into the elongate portion from the first sleeve end. The inner surface defines a sleeve cavity configured to receive at least a portion of the pin. The first ratchet ring is disposed within the sleeve cavity and configured to engage the pin. The first ratchet ring comprises a first bore configured to receive the pin. The second ratchet ring is disposed within the sleeve cavity and configured to engage the sleeve. The second ratchet ring comprises a second bore configured to receive the pin. The first ratchet ring is configured to engage the second ratchet ring.

According to another non-limiting aspect of the present disclosure, a method for fastening is provided. The method comprises inserting a pin of a multi-piece fastener into a sleeve cavity of a sleeve of the multi-piece fastener. The multi-piece fastener comprises the pin, the sleeve, a first ratchet ring, and a second ratchet ring. The sleeve comprises a first sleeve end, a second sleeve end, an elongate portion extending from the first sleeve end to the second sleeve end, and an inner surface extending into the elongate portion from the first sleeve end. The inner surface defines the sleeve cavity. The first ratchet ring is disposed within the sleeve cavity and configured to engage the pin. The first ratchet ring comprises a first bore. The second ratchet ring is disposed within the sleeve cavity and configured to engage the sleeve. The second ratchet ring comprises a second bore. The first ratchet ring is configured to engage the second ratchet ring. The method comprises inserting the pin through the first ratchet ring and the second ratchet ring. The method comprises rotating the pin and forcibly contacting the first ratchet ring with the pin such that the first ratchet ring rotates while engaged with the second ratchet ring to provide resistance to rotation of the pin.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is cross-sectional side view of a non-limiting embodiment of a multi-piece fastener according to the present disclosure;

FIG. 2 is a cross-sectional side view of the multi-piece fastener of FIG. 1 installed in a structure;

FIG. 3 is a exploded view of a portion of a multi-piece fastener according to the present disclosure with a sleeve shown in partial cross-section;

FIG. 4 is a detail view of area 4 of the multi-piece fastener in FIG. 2;

FIG. 5 is a cross-sectional bottom view of a second ratchet ring and a sleeve of a non-limiting embodiment of a multi-piece fastener according to the present disclosure;

FIG. 6 is a side view of a first ratchet ring and a second ratchet ring of a non-limiting embodiment of a multi-piece fastener according to the present disclosure;

FIG. 7 is a cross-sectional bottom view of a first ratchet ring, a sleeve, and a pin of a of a portion of a non-limiting embodiment of a multi-piece fastener according to the present disclosure;

FIG. 8 is a detail view of area 8 of the multi-piece fastener of FIG. 7;

FIG. 9 is a cross-sectional side view of a portion of a non-limiting embodiment of a multi-piece fastener according to the present disclosure in a first configuration with a structure;

FIG. 10 is a detail view of area 10 of the multi-piece fastener of FIG. 9;

FIG. 11 is a top view of the spring ring of the multi-piece fastener of FIG. 9;

FIG. 12 is a cross-sectional side view of the multi-piece fastener of FIG. 9 in a second configuration with the structure;

FIG. 13 is an exploded view of a non-limiting embodiment of a multi-piece fastener according to the present disclosure; and

FIG. 14 is a cross-sectional side view of a non-limiting embodiment of a multi-piece fastener according to the present disclosure in a first configuration with a structure.

Corresponding reference characters indicate corresponding parts throughout the several views. The exemplifications set out herein illustrate certain non-limiting embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed fastening sleeves, multi-piece fasteners, pins, and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

It may be desirable for a multi-piece fastener to be resistant to undesired removal after installation. Typically, to achieve a desired resistance to removal force, it may be necessary to apply increasing torque force to rotate the multi-piece fastener as the installation progresses and/or it may be necessary to install the multi-piece fastener to a predetermined depth (e.g., only applicable to a predetermined thickness of a structure). For example, the multi-piece fastener may comprise a spring that is continually compressed as the pin of the multi-piece fastener is installed and/or the multi-piece fastener may include an obstruction that does not allow the pin to extend beyond a predetermined distance. The multi-piece fastener may also be provided with a locking compound, which is typically not reusable.

In light of these issues, the present inventors have developed multi-piece fasteners and methods for fastening that can advantageously control a torque force required for installation of the multi-piece fastener and/or achieve a desirable tensile strength of the multi-piece fastener when installed in the structure.

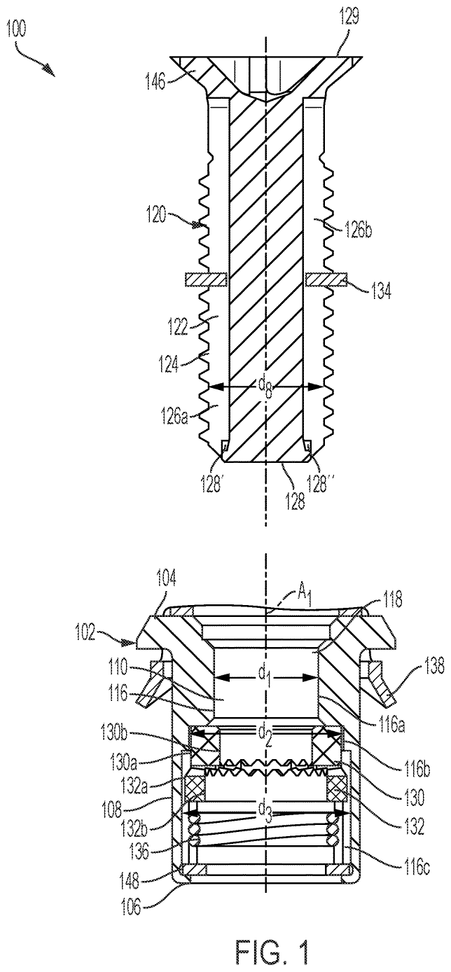

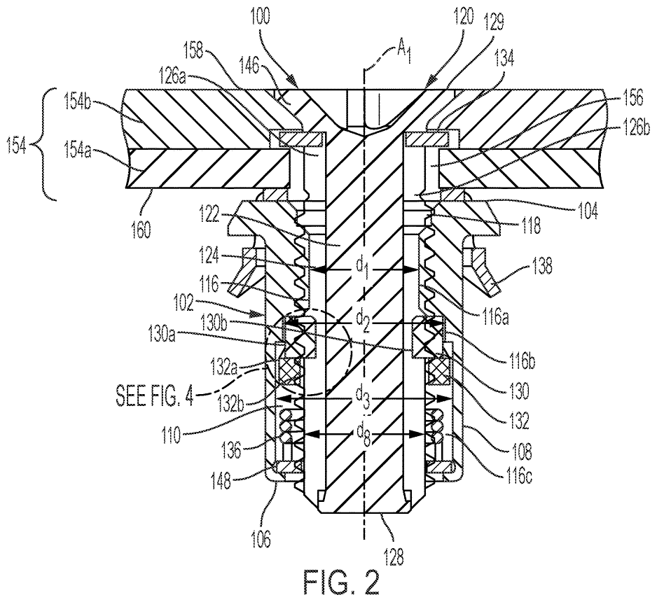

Referring to FIGS. 1-2, a non-limiting embodiment of a multi-piece fastener 100 according to the present disclosure is provided. The multi-piece fastener 100 can comprise a sleeve 102, a pin 120, a first ratchet ring 130, a second ratchet ring 132 and a spring 136. Optionally, the multi-piece fastener 100 can comprise a retaining ring 134 and a cage 138.

The sleeve 102 can comprise a first sleeve end 104, a second sleeve end 106, an elongate portion 108 intermediate the first sleeve end 104 and the second sleeve end 106, and an inner surface 116. The elongate portion 108 can define a longitudinal axis, AI, of the sleeve 102. The inner surface 116 extends from the first sleeve end 104 towards the second sleeve end 106. In various non-limiting embodiments, the inner surface 116 extends from the first sleeve end 104 through the elongate portion 108 and to the second sleeve end 106. The inner surface 116 can define a sleeve cavity 110 that extends into the elongate portion 108 from the first sleeve end 104 towards the second sleeve end 106. In various non-limiting embodiments, the sleeve cavity 110 extends completely through the elongate portion 108 such that the sleeve 102 is generally tubular where the first sleeve end 104 and the second sleeve end 106 are open.

The inner surface 116 can comprise a variable shape and/or diameter. For example, the inner surface 116 can comprise a first portion 116a, a second portion 116b, and a third portion 116c, which may be the same or different. For example, the first portion 116a can comprise a diameter, di, the second portion 116b, can comprise a diameter, d₂, and the third portion 116c, can comprise a third diameter, d₃. The diameter, d₁, can be less than the diameter, d₂, such that the first ratchet ring 130 and the second ratchet ring 132 are inhibited from traversing into the region of the sleeve cavity 110 defined by the first portion 116a. In various non-limiting embodiments, the diameter, d₂, can be sized to receive the first ratchet ring 130 and substantially align the first ratchet ring 130 with the longitudinal axis, A₁. The second portion 116b can be substantially cylindrical and the outer surface 130a of the first ratchet ring 130 can be substantially cylindrical such that the first ratchet ring 130 can rotate independently of the sleeve 102 about the longitudinal axis, A₁.

The third portion 116c can comprise a shape suitable to engage the second ratchet ring 132, such that the sleeve 102 and the second ratchet ring 132 are inhibited from rotating independently of one another about the longitudinal axis, A₁. For example, the third portion 116c can comprise a first physical feature that inhibits the rotation of the second ratchet ring 132 about the longitudinal axis, A₁, such as, for example, a substantially flat side, a rib, a spline, an indent, a knurl, a lobe, a bore, a recess, a tab, or a similar structural feature. The second ratchet ring 132 can comprise a second physical feature that engages the first physical feature of the third portion 116c.

Referring again to FIG. 1, the second sleeve end 106 can be open, the sleeve cavity 110 can extend completely through the sleeve 102, and the pin 120 may extend completely through the sleeve cavity 110 when installed. The pin 120 can extend through the second sleeve end 106 such that the pin 120 can be installed at varying depths in the multi-piece fastener 100, which can enable the multi-piece fastener to be installed in varying structure thicknesses. In various non-limiting embodiments, the second sleeve end 106 can be closed such that the sleeve cavity 110 does not extend all the way through the elongate portion 108.

The pin 120 can comprise a first pin end 128, a second pin end 129, and a shank 122. The shank 122 can define a longitudinal axis of the pin 120, extending from the first pin end 128 to the second pin end 129. The longitudinal axis of the pin 120 may be coextensive with the longitudinal axis, Ai, of the sleeve 102, and the longitudinal axes are referred to interchangeably herein in connection with the present embodiments. The shank 122 can comprise a shape suitable to be received within the sleeve cavity 110 of the sleeve 102.

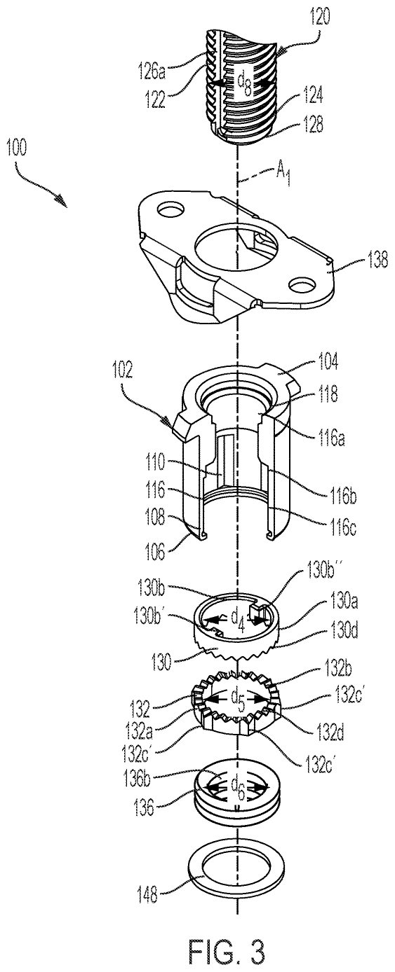

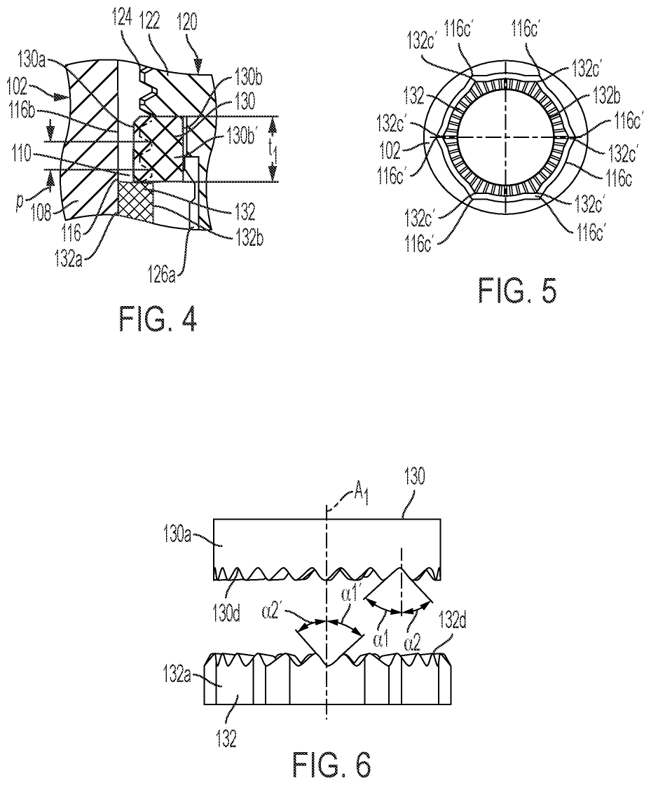

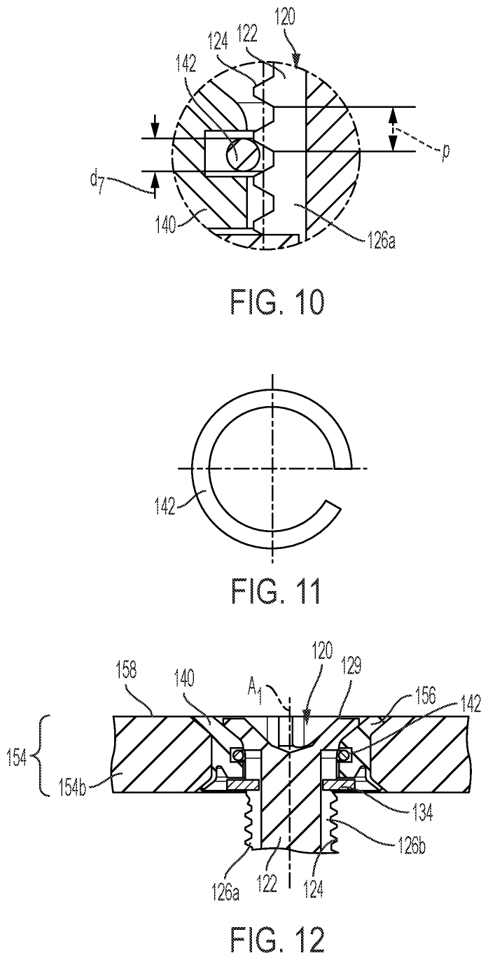

Referring to FIG. 3, in various non-limiting embodiments, the shank 122 comprises a threaded portion 124. In various non-limiting embodiments, the shank 122 comprises an unthreaded portion. The first portion 116a of the inner surface 116 can comprise a threaded portion 118 complimentary to the threaded portion 124 of the shank 122. The threaded portions 118 and 124 may comprises various suitable threads, such as, for example, a right handed thread, a left handed thread, a single-start lead thread, a multi-start lead thread, and/or other thread type. As illustrated in FIGS. 4 and 10, the threaded portion 124 of the pin 120 can comprise a pitch, p.

The pin 120 can comprise a groove extending along at least a portion of a longitudinal axis, A₁. For example, as shown in FIGS. 1-2, the shank 122 comprises two longitudinal grooves 126a-b. In various non-limiting embodiments, the pin 120 can comprise a different number of grooves or other feature(s) configured to engage the first ratchet ring 130 and minimize interference of the first ratchet ring 130 with the threaded portion 118 of the sleeve 102.

The shank 122 can be intermediate the first pin end 128 and the second pin end 129. The shank 122 can be dimensioned so that it can be inserted and extend at least partially into the sleeve cavity 110 and, optionally, through the second sleeve end 106. Referring to FIG. 2, when the shank 122 is inserted in the sleeve cavity 110, the first pin end 128 can be disposed proximal to the second sleeve end 106, and a head portion 146 of the second pin end 129 can be disposed proximal to the first sleeve end 104. The head portion 146 can inhibit the pin 120 from completely passing through a bore 156 in a structure 154 and can contact the structure 154 or other feature to inhibit the pin 120 from extending beyond a predetermined distance. In various non-limiting embodiments, the head portion 146 can be tapered and/or configured to mount substantially flush and/or at a desired distance from flush with the structure 154.

Referring to FIGS. 1-3, the sleeve cavity 110 of the sleeve 102 can be configured to at least partially receive the shank 122 of the pin 120 therein. For example, the sleeve cavity 110 can comprise a shape suitable to receive the shank 122 of the pin 120. The sleeve 102, including the inner surface 116, can be configured to retain the pin 120, such as, for example, by friction fit of the threaded portions 118 and 124.

The multi-piece fastener 100 can be configured to provide a substantially uniform installation torque and/or a substantially uniform removal torque. The installation and removal torque can be provided by an arrangement of the first ratchet ring 130, the second ratchet ring 132, and the spring 136.

Referring to FIGS. 1-2, the first ratchet ring 130 can be disposed within the sleeve cavity 110 and can comprise a bore 130b configured to receive the pin 120. The first ratchet ring 130 can be configured to engage the pin 120. For example, referring to FIG. 7, the first ratchet ring 130 can comprise a protrusion 130b′ and a protrusion 130b″ extending into the bore 130b. Protrusions 130b′ and 130b″ can be individually selected from, for example, a rib, a spline, a knurl, a lobe, a tab, or a similar structural feature. The grooves 126a-126b of the pin 120 can be configured to receive the protrusions 130b′ and 130b″ and frictionally and/or physically engage the protrusions 130b′ and 130b″ such that rotation of the shank 122 rotates the first ratchet ring 130. As illustrated in FIG. 8, the groove 126a comprises a width, w₁, and the protrusion 130b′ comprises a width, w₂. The width, w₁, can be greater than the width, W₂, such that the groove 126a can receive protrusion 130b′ and enable the protrusion 130b′ to traverse along the longitudinal axis, A₁. The groove 126b can have a configuration that is the same as or different from groove 126a, and the protrusion 130b″ can have a configuration that is the same as or different from the protrusion 130b′.

Referring to FIG. 4, the first ratchet ring 130 can comprise a thickness, t₁. The thickness, t₁, of the first ratchet ring can be greater than the pitch, p, of the threaded portion 124 of the pin 120, such as, for example, at least 2 times the pitch, p, of the threaded portion 124 of the pin 120. The thickness, t₁, can inhibit the first ratchet ring 130 from becoming jammed within the sleeve cavity 110.

Referring again to FIGS. 1-2, the second ratchet ring 132 can be disposed within the sleeve cavity 110 and can comprise a bore 132b configured to receive the pin 120. The second ratchet ring 132 may allow the pin 120 to rotate independently about the longitudinal axis, A₁, and may not engage the pin 120. For example, the bore 132b may be free of protrusions and/or substantially smooth and/or cylindrical.

Referring to FIG. 5, the second ratchet ring 132 can be configured to engage the inner surface 116c′ of the sleeve 102. For example, the second ratchet ring 132 and the third portion 116c of the inner surface 116 of the sleeve 102 can comprise complimentary shapes that inhibit the second ratchet ring 132 from rotating about the longitudinal axis, A₁, independently of a rotation of the sleeve 102. For example, the outer surface 132a of the second ratchet ring 132 can comprise a physical feature, such as, for example, a substantially flat side, a rib, a spline, an indent, a knurl, a lobe, a bore, a recess, a tab, or a similar structural feature that frictionally engages with a corresponding physical feature on the third portion 116c. The corresponding physical feature on the third portion 116c may be, for example, a substantially flat side, a rib, a spline, an indent, a knurl, a lobe, a bore, a recess, a tab, or a similar structural feature. In various non-limiting embodiments, the outer surface 132a comprises protrusions 132c′ configured to engage indents 116c′ of the third portion 116c.

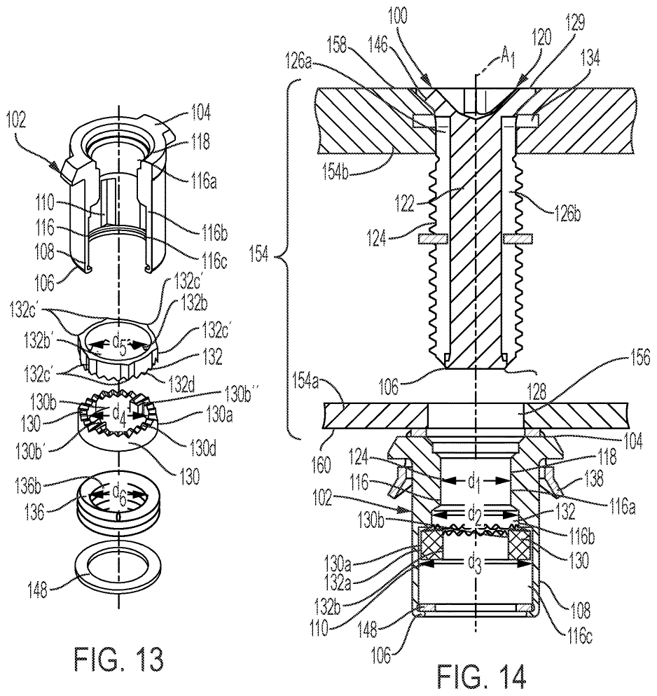

As illustrated in FIGS. 1-3, the first ratchet ring 130 and the second ratchet ring 132 are separate from the sleeve 102. The first ratchet ring 130 can be intermediate the second ratchet ring 132 and the first portion 116a, as illustrated in FIGS. 1-3, or the second ratchet ring 132 can be intermediate the first ratchet ring 130 and the first portion 116a, as illustrated in FIG. 13. In various non-limiting embodiments, referring to FIG. 14, the second ratchet ring 132 can be integral with the sleeve 102, and the first ratchet ring 130 can separate from the sleeve 102. For example, the second ratchet ring 132 can be formed on the inner surface 116 of the sleeve 102 and the third portion 116c may not be present.

The first ratchet ring 130 is configured to engage the second ratchet ring 132. For example, referring to FIG. 6, the first ratchet ring 130 can comprise a surface 130d comprising teeth, and the second ratchet ring 132 can comprise a surface 132d comprising teeth. The teeth on the surface 130d can be configured to engage the teeth on the surface 132d, such that the two surfaces are frictionally engaged. The rotation of the first ratchet ring 130 about the longitudinal axis, A₁, requires one to apply a predetermined level of torque to the first ratchet ring 130 to overcome the frictional engagement of the first ratchet ring 130 and the second ratchet ring 132. For example, referring to FIGS. 1-2, the first ratchet ring 130 and the second ratchet ring 132 may be urged into contact with one another by spring 136. When the first ratchet ring 130 is rotated about the longitudinal axis, A₁, independent of the second ratchet ring 132, the teeth of the surface 130d and the teeth of the surface 132d slide along each other such that the first ratchet ring 130 and the second ratchet ring 132 move away from each other in the direction of the longitudinal axis, A₁. This allows the teeth on the respective surfaces 130d, 132d to clear one another and thereby compress the spring 136.

Referring to FIG. 6, the teeth on the surface 130d can comprise a closing angle, α1, and an opening angle, α₂. The teeth on the surface 132d can comprise a complementary closing angle, α₁′, and a complementary opening angle, α₂′. Each closing angle, α₁, α₁′ can be greater than each opening angle, α₂, α₂′ such that the removal torque is greater than the installation torque.

Referring yet again to FIG. 3, the spring 136 can comprise a bore 136b configured to receive the pin 120. The bore 130b of the first ratchet ring 130 comprises a diameter, d₄, the bore 132b of the second ratchet ring 132b comprises a diameter, d₅, the bore 136b of the spring 136 comprises a diameter, d₆, and the shank 122 of the pin 120 comprises a diameter, d₈. The diameter, d₈, can be less than the diameter, d₄, the diameter, d₅, and the diameter, d₆, such that the pin 120 can pass through the bores 130b, 132b, and 136b as the pin 120 is installed into the sleeve 102. In this way, a substantially uniform installation torque and a substantially uniform removal torque can be required to rotate the pin 120 about the longitudinal axis, A₁, as the spring 136 is minimally, if at all, compressed during installation (e.g., a distance along the longitudinal axis, A₁, sufficient for the teeth on the surfaces 130d and 132d to clear one another). The spring 136 can apply a substantially constant force to the first ratchet ring 130 or second ratchet ring 132, such that the ratchet rings 130 and 132 remain in friction contact. Therefore, varying lengths of pins can be received by the sleeve 102, and the multi-piece fastener 100 can be installed in varying thicknesses of structures.

In various non-limiting embodiments, the second sleeve end 106 of the sleeve 102 can be swaged to retain the first ratchet ring 130, the second ratchet ring 132, and the spring 136 within the sleeve cavity 110. For example, a retainer 148 can be inserted into the sleeve cavity 110 and the second sleeve end 106 can be swaged to contact the retainer 148 to inhibit the retainer 148 from traversing out of the sleeve cavity 110. The retainer 148 can contact the first ratchet ring 130, the second ratchet ring 132, or the spring 136, depending on the configuration, and inhibit the first ratchet ring 130, the second ratchet ring 132, and the spring 136 from more than minimal axial movement along the longitudinal axis, A₁, and/or from traversing out of the sleeve cavity 110.

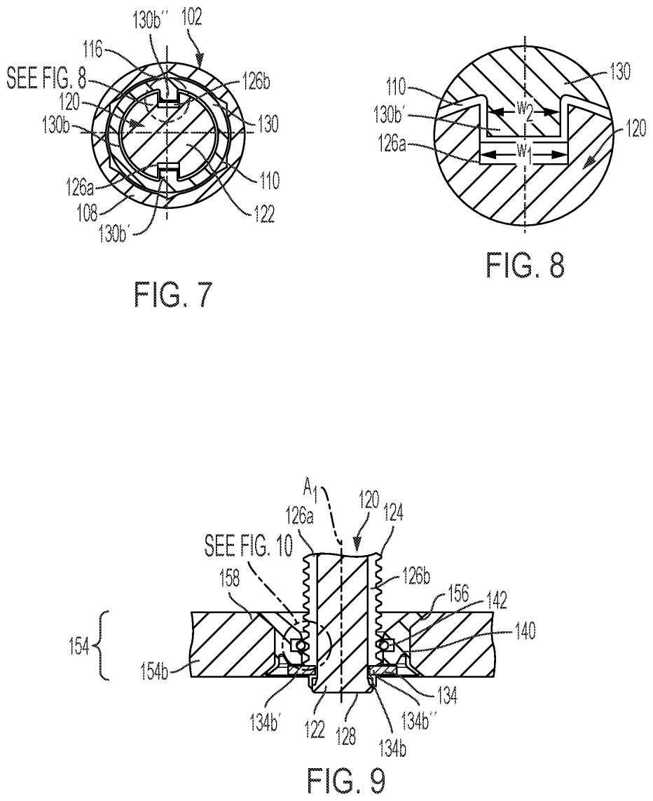

Referring to FIG. 9, the retaining ring 134 can be configured to hold the pin 120 in the second layer 154b of the structure 154. The retaining ring 134 can comprise a bore 134b and a protrusion extending into the bore 134b. For example, the retaining ring 134 can comprise two protrusions, 134b′ and 134b″, each of which may be, individually, for example, a rib, a spline, a knurl, a lobe, a tab, or a similar structural feature. The grooves 126a-126b of the pin 120 can be configured to receive the protrusions 134b′ and 134b″ and frictionally and/or physically engage the protrusions 134b′ and 134b″ such that rotation of the shank 122 rotates the retaining ring 134. In various non-limiting embodiments, the transition of the grooves 126a-126b to the first pin end 128 can be configured to only allow axial movement of the retaining ring 134 not further than the first pin end 128 without limiting the axial movement of the first ratchet ring 130 and/or second ratchet ring 132. For example, the first pin end 128 can comprise protrusions 128′and 128″ configured to frictionally and/or physically engage the retaining ring 134.

Referring to FIG. 2, the cage 138 can be configured to receive the sleeve 102. The cage 138 can be installed onto the second side 160 of the structure 154 by a fastener, a pin, an adhesive, or other fastening method. The cage 138 may be used to hold the sleeve 102 to the first side 160 of the structure 154 when the pin 120 is not engaged with the sleeve 102.

In various non-limiting embodiments and as shown in FIG. 9, the multi-piece fastener 100 can comprise a guiding sleeve 140 configured to receive the pin 120. The guiding sleeve 140 can comprise a spring ring 142 configured to retain the pin 120 by frictionally engaging threaded portion 124. As shown in FIG. 10, the spring ring 142 can comprises a thickness, d₇, greater than half of a pitch, p, of the threaded portion 124.

The multi-piece fastener 100 can be sized as appropriate for the intended application. For example, in certain non-limiting embodiments the diameter, da, of the shank 122 can be in a range of 0.06 inch to 4 inches, and the sleeve 102 can be sized to receive the shank 122.

The multi-piece fastener 100, including the sleeve 102 and the pin 120, can comprise any suitable material, such as, for example, a metal, a metal alloy, a polymer, or another suitable material. For example, in various non-limiting embodiments, the multi-piece fastener 100 can comprise at least one of aluminum, an aluminum alloy, titanium, a titanium alloy, nickel, a nickel alloy, iron, an iron alloy, and a carbon fiber composite material.

Referring to FIG. 2, the multi-piece fastener 100 can be installed into the bore 156 in the structure 154. As illustrated, the bore 156 can extend through the structure 154 from the first side 158 to the second side 160 of the structure 154. The structure 154 can comprise, for example, at least one of a metal, a metal alloy, a composite material, or another suitable material. For example, in certain non-limiting embodiments, the structure 154 can comprise one or more of aluminum, an aluminum alloy, titanium, a titanium alloy, nickel, a nickel alloy, iron, an iron alloy, and a carbon fiber composite material. In various non-limiting embodiments, the structure 154 in which the multi-piece fastener 100 is installed comprises aluminum and/or an aluminum alloy, such as, for example, a 7075 aluminum alloy. In various non-limiting embodiments, the structure 154 into which the multi-piece fastener 100 can be installed can be configured as, or as a part or region of, at least one of an aerospace component or structure, an automotive component or structure, a transportation component or structure, a building and construction component or structure, or another component or structure.

In certain embodiments, the structure 154 can comprise two or more layers of material. For example, as illustrated in FIG. 2, the structure 154 can comprise a first layer 154a and a second layer 154b, which may be the same material or different materials. The first layer 154a can be positioned intermediate the second layer 154b and the sleeve 102 when the multi-piece fastener 100 is installed. In various non-limiting embodiments, the second layer 154b is adjacent to or contacts the pin 120.

Additionally, in various non-limiting embodiments, the first pin end 128 can be sized and configured to facilitate alignment of the pin 120 with the bore 156, thereby allowing the first pin end 128 to readily move into and through the bore 156. In various non-limiting embodiments, the head portion 146 can be sized and configured to inhibit the pin 120 from traversing into the bore 156 beyond a predetermined distance.

To install the multi-piece fastener 100, the sleeve 102 is positioned in alignment with the second side 160 of the bore 156, and the first pin end 128 of the pin 120 is positioned in alignment with the first side 158 of the bore 156 and inserted through the bore 156. In various non-limiting embodiments, the cage 138 is attached to the structure 154 prior to inserting the pin 120.

The first pin end 128 can be inserted into and through the sleeve cavity 110 of the sleeve 102. Inserting the first pin end 128 can comprise rotating the pin 120 about the longitudinal axis, Ai, and engaging the threaded portion 118 with the threaded portion 124. The pin 120, including the first pin end 128, can be inserted through the first ratchet ring 130, the second ratchet ring 132, and, optionally, the spring 136 and the second sleeve end 106. The pin 120 can be rotated and forcibly contacted with the first ratchet ring 130 such that the first ratchet ring 130 rotates while engaged with the second ratchet ring 132, to provide resistance to rotation of the pin 120.

The tightening of the pin 120 into the sleeve 102 can decrease the width of a gap, if present, between the first layer 154a and the second layer 154b of the structure 154 and forcibly contact the head portion 146 of the pin 120 with the structure 154 and/or guiding sleeve 140.

Various aspects of non-limiting embodiments of inventions according to the present disclosure include, but are not limited to, the aspects listed in the following numbered clauses.

Clause 1. A multi-piece fastener comprising:
a pin;
a sleeve comprising
   a first sleeve end,
   a second sleeve end,
   an elongate portion extending from the first sleeve end to the second sleeve end, and
   an inner surface extending into the elongate portion from the first sleeve end, the inner surface defining a sleeve cavity configured to receive at least a portion of the pin;
a first ratchet ring disposed within the sleeve cavity and configured to engage the pin, the first ratchet ring comprising a first bore configured to receive the pin; and
a second ratchet ring disposed within the sleeve cavity and configured to engage the sleeve, the second ratchet ring comprising a second bore configured to receive the pin, wherein the first ratchet ring is configured to engage the second ratchet ring.

Clause 2. The multi-piece fastener of clause 1, wherein:
the first bore of the first ratchet ring comprises a first diameter;
the second bore of the second ratchet ring comprises a second diameter; and
the pin comprises a shank comprising a third diameter, wherein the third diameter is less than the first diameter and the second diameter.

Clause 3. The multi-piece fastener of clause 2, wherein:
the shank comprises a groove extending along at least a portion of a longitudinal axis of the pin extending from a first pin end of the pin toward a second pin end of the pin;
the first ratchet ring comprises a first protrusion extending into the first bore; and
the groove is configured to receive the first protrusion such that rotation of the shank rotates the first ratchet ring.

Clause 4. The multi-piece fastener of clause 3, wherein the groove comprises a first width, the protrusion comprises a second width, and the first width is greater than the second width.

Clause 5. The multi-piece fastener of any of clauses 3-4, further comprising a retaining ring comprising a third bore and a second protrusion extending into the third bore, wherein the groove is configured to receive the second protrusion of the retaining ring.

Clause 6. The multi-piece fastener of any of clauses 1-5, wherein the inner surface comprises a first threaded portion and the shank comprises a second threaded portion.

Clause 7. The multi-piece fastener of clause 6, wherein the first ratchet ring comprises a thickness, the second threaded portion comprises a pitch, and the thickness of the first ratchet ring is greater that the pitch of the second threaded portion.

Clause 8. The multi-piece fastener of any of clauses 6-7, wherein the first threaded portion comprises one of a single-start lead and a multi-start lead.

Clause 9. The multi-piece fastener of any of clauses 1-8, wherein the first ratchet ring comprises a first surface comprising first teeth, the second ratchet ring comprises a second surface comprising second teeth, and the first teeth are configured to engage the second teeth.

Clause 10. The multi-piece fastener of clause 9, wherein the first teeth comprise a closing angle and an opening angle, and the closing angle is greater than the opening angle.

Clause 11. The multi-piece fastener of any of clauses 1-10, wherein the second ratchet ring is configured to engage the inner surface of the sleeve and inhibit rotation of the second ratchet ring about a longitudinal axis extending from a first pin end of the pin to a second pin end of the pin.

Clause 12. The multi-piece fastener of any of clauses 1-11, wherein the second ratchet ring is integral with the sleeve and the first ratchet ring is separate from the sleeve.

Clause 13. The multi-piece fastener of any of clauses 1-12, further comprising a spring comprising a third bore configured to receive the pin, wherein the spring urges the first ratchet ring and the second ratchet ring into contact with one another.

Clause 14. The multi-piece fastener of clause 13, wherein the second ratchet ring is intermediate the first ratchet ring and the spring.

Clause 15. The multi-piece fastener of any of clauses 1-14, wherein the first ratchet ring is intermediate the second ratchet ring and the spring.

Clause 16. The multi-piece fastener of any of clauses 1-15, wherein the sleeve cavity extends completely through the sleeve.

Clause 17. The multi-piece fastener of any of clauses 1-16, further comprising a cage configured to receive the sleeve.

Clause 18. The multi-piece fastener of any of clauses 1-17, further comprising a guiding sleeve configured to receive the pin, wherein the guiding sleeve comprises a spring ring configured to retain the pin.

Clause 19. The multi-piece fastener of clause 18, wherein the spring ring comprises a thickness greater than half of a pitch of the second threaded portion.

Clause 20. A method for fastening, the method comprising:
inserting a pin of a multi-piece fastener into a sleeve cavity of a sleeve of the multi-piece fastener, the multi-piece fastener comprising
   the pin,
   the sleeve comprising
      a first sleeve end,
      a second sleeve end,
      an elongate portion extending from the first sleeve end to the second sleeve end, an inner surface extending into the elongate portion from the first sleeve end, the inner surface defining the sleeve cavity,
      a first ratchet ring disposed within the sleeve cavity and configured to engage the pin, the first ratchet ring comprising a first bore, and a second ratchet ring disposed within the sleeve cavity and configured to engage the sleeve, the second ratchet ring comprising a second bore, wherein the first ratchet ring is configured to engage the second ratchet ring;
inserting the pin through the first ratchet ring and the second ratchet ring; and
rotating the pin and forcibly contacting the first ratchet ring with the pin such that the first ratchet ring rotates while engaged with the second ratchet ring to provide resistance to rotation of the pin.

Clause 21. A method for fastening, the method comprising:
inserting the pin of the multi-piece fastener of any of clauses 1-19 into the sleeve cavity of the sleeve of the multi-piece fastener;
inserting the pin through the first ratchet ring and the second ratchet ring; and
rotating the pin and forcibly contacting the first ratchet ring with the pin such that the first ratchet ring rotates while engaged with the second ratchet ring to provide resistance to rotation of the pin.

One skilled in the art will recognize that the fastening sleeves, multi-piece fasteners, structures, methods, operations/actions, and objects described herein, and the accompanying discussion, are non-limiting examples presented for the sake of conceptual clarity, and that various modifications to the disclosed configurations are contemplated. Consequently, as used herein, the specific examples/embodiments set forth, and the accompanying discussion, are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

Any references herein to “various embodiments”, “some embodiments”, “one embodiment”, “an embodiment”, a “non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

1. A multi-piece fastener comprising:
a pin;
a sleeve comprising
a first sleeve end,
a second sleeve end,
an elongate portion extending from the first sleeve end to the second sleeve end, and
an inner surface extending into the elongate portion from the first sleeve end, the inner surface defining a sleeve cavity configured to receive at least a portion of the pin;
a first ratchet ring disposed within the sleeve cavity and configured to engage the pin, the first ratchet ring comprising a first bore configured to receive the pin, and
a second ratchet ring disposed within the sleeve cavity and configured to engage the sleeve, the second ratchet ring comprising a second bore configured to receive the pin, wherein the first ratchet ring is configured to engage the second ratchet ring; and
a spring comprising a third bore configured to receive the pin, wherein the spring urges the first ratchet ring and the second ratchet ring into contact with one another.

2. The multi-piece fastener of claim 1, wherein:
the first bore of the first ratchet ring comprises a first diameter;
the second bore of the second ratchet ring comprises a second diameter; and
the pin comprises a shank comprising a third diameter, wherein the third diameter is less than the first diameter and the second diameter.

3. The multi-piece fastener of claim 2, wherein:
the shank comprises a groove extending along at least a portion of a longitudinal axis of the pin extending from a first pin end of the pin toward a second pin end of the pin;
the first ratchet ring comprises a first protrusion extending into the first bore; and
the groove is configured to receive the first protrusion such that rotation of the shank rotates the first ratchet ring.

4. The multi-piece fastener of claim 3, wherein the groove comprises a first width, the protrusion comprises a second width, and the first width is greater than the second width.

5. The multi-piece fastener of claim 3, further comprising a retaining ring comprising a third bore and a second protrusion extending into the third bore, wherein the groove is configured to receive the second protrusion of the retaining ring.

6. The multi-piece fastener of claim 1, wherein the inner surface comprises a first threaded portion and the shank comprises a second threaded portion.

7. The multi-piece fastener of claim 6, wherein the first ratchet ring comprises a thickness, the second threaded portion comprises a pitch, and the thickness of the first ratchet ring is greater that the pitch of the second threaded portion.

8. The multi-piece fastener of claim 6, wherein the first threaded portion comprises one of a single-start lead and a multi-start lead.

9. The multi-piece fastener of claim 1, wherein the first ratchet ring comprises a first surface comprising first teeth, the second ratchet ring comprises a second surface comprising second teeth, and the first teeth are configured to engage the second teeth.

10. The multi-piece fastener of claim 9, wherein the first teeth comprise a closing angle and an opening angle, and the closing angle is greater than the opening angle.

11. The multi-piece fastener of claim 1, wherein the second ratchet ring is configured to engage the inner surface of the sleeve and inhibit rotation of the second ratchet ring about a longitudinal axis extending from a first pin end of the pin to a second pin end of the pin.

12. The multi-piece fastener of claim 1, wherein the second ratchet ring is integral with the sleeve and the first ratchet ring is separate from the sleeve.

13. (canceled)

14. The multi-piece fastener of claim 1, wherein the second ratchet ring is intermediate the first ratchet ring and the spring.

15. The multi-piece fastener of claim 1, wherein the first ratchet ring is intermediate the second ratchet ring and the spring.

16. The multi-piece fastener of claim 1, wherein the sleeve cavity extends completely through the sleeve.

17. The multi-piece fastener of claim 1, further comprising a cage configured to receive the sleeve.

18. The multi-piece fastener of claim 1, further comprising a guiding sleeve configured to receive the pin, wherein the guiding sleeve comprises a spring ring configured to retain the pin.

19. The multi-piece fastener of claim 18, wherein the spring ring comprises a thickness greater than half of a pitch of the second threaded portion.

20. A method for fastening, the method comprising:
inserting a pin of a multi-piece fastener into a sleeve cavity of a sleeve of the multi-piece fastener, the multi-piece fastener comprising
the pin,
the sleeve comprising
a first sleeve end,
a second sleeve end,
an elongate portion extending from the first sleeve end to the second sleeve end, an inner surface extending into the elongate portion from the first sleeve end, the inner surface defining the sleeve cavity,
a first ratchet ring disposed within the sleeve cavity and configured to engage the pin, the first ratchet ring comprising a first bore, and a second ratchet ring disposed within the sleeve cavity and configured to engage the sleeve, the second ratchet ring comprising a second bore, wherein the first ratchet ring is configured to engage the second ratchet ring;
inserting the pin through the first ratchet ring and the second ratchet ring; and
rotating the pin and forcibly contacting the first ratchet ring with the pin such that the first ratchet ring rotates while engaged with the second ratchet ring to provide resistance to rotation of the pin.
